(19) United States
(12) Patent Application Publication
(10) Pub. No.: US 2018/0193769 A1
(43) Pub. Date: Jul. 12, 2018

(54) METHOD FOR TREATING WELL FLUIDS TO REMOVE HYDROGEN SULFIDE THEREFROM

(71) Applicant: Pro-Ject Chemicals Holdings, LLC, The Woodlands, TX (US)

(72) Inventor: Robert N. Ayres, The Woodlands, TX (US)

(21) Appl. No.: 15/399,771

(22) Filed: Jan. 6, 2017

(51) Int. Cl. B01D 19/00; E21B 43/40; E21B 43/16

(52) U.S. Cl. CPC B01D 19/0005; E21B 43/16; E21B 43/40; B01D 19/0063

(57) ABSTRACT

A method for scavenging hydrogen sulfide from fluids produced into a well includes pressurizing a hydrogen sulfide scavenging reagent to a pressure above a pressure in the well. At selected times the pressurized hydrogen sulfide scavenging reagent is enabled to flow into the well. Fluid produced from the well is stored at a pressure extant on the well. At selected times an hydraulic connection is made between the stored, produced fluid and the well so that the produced fluid flows into the well by gravity. In some embodiments, the reagent is triazine.

### CROSS-REFERENCE TO RELATED APPLICATIONS

Not Applicable

### STATEMENT REGARDING FEDERALLY SPONSORED RESEARCH OR DEVELOPMENT

Not applicable.

### NAMES OF THE PARTIES TO A JOINT RESEARCH AGREEMENT

Not Applicable.

### BACKGROUND

The present disclosure relates generally to the field of chemical treatment methods and apparatus for use with hydrocarbon producing wells. More specifically, the invention relates to chemical treatment of wells to enable in-situ scavenging (abatement) of hydrogen sulfide from formation fluids in the well.

Wells drilled for the production of hydrocarbons may encounter subsurface formations that have substantial concentrations of hydrogen sulfide. Hydrogen sulfide may be present in gas in the formation, or may be present in solutions of gas dissolved in oil in the formation. In other cases, certain bacteria in the well fluids may cause chemical reactions that generate hydrogen sulfuide. In any such case, special equipment is provided at the surface so that the hydrogen sulfide may be removed from produced gas and/or exsolved gas. Such surface equipment may be configured to expose the produced and/or exsolved gas to triazine, which is a commonly used hydrogen sulfide (H₂S) scavenging reagent.

Triazine, is a heterocyclic structure similar to cyclohexane, but with three carbon atoms replaced by nitrogen atoms. Oilfield terminology of triazine differs from the IUPAC convention, triazinane. Further variations involving substitutions of the hydrogen atoms with other functional groups are used in other industries. Different substitutions result in different reactivity with H₂S, changes in solubility of triazine, and changes in the solubility of the reactant products (the “R” groups). Consequently, triazine can be “tailored” to better suit the application or disposal considerations.

Triazine may be used to scavenge H₂S by various methods. In direct-injection applications, the triazine is sprayed directly into the gas or mixed fluid stream, usually with an atomizing quill. H₂S removal rate is dependent upon the H₂S dissolution into the triazine solution, rather than the reaction rate. As a result, gas flow rate, contact time, and misting size and distribution contribute to the final scavenger performance. The direct injection method is suitable for removing H₂S when there is good annular-mist flow and sufficient time to react. Most suppliers recommend a minimum of 15-20 seconds of contact time of the gas with the scavenging product for best results. Typical efficiencies are lower than for other methods due to the H₂S dissolution into the product, but approximately 40% removal efficiency can reasonably be expected. In order for direct injection to be effective, careful consideration of injection location and product selection should be used.

In a contactor (“bubble”) tower, the feed gas is bubbled through a tower filled with triazine liquid solution. As the gas bubbles up through the triazine solution, gas dissolves into the triazine and H₂S is removed. The limiting factors in contactor tower methods are the surface area of the bubbles, the concentration of the triazine solution, and bubble path time (contact time). Finer bubbles provide a better reaction rate, but they can produce unwanted foaming. Contactor tower scavenging is not appropriate for high gas flow rates. Contactor towers have much greater H₂S removal efficiencies than direct injection, up to 80%. As a result, less triazine is used and a significant reduction in operating expenditures can be realized. However, the contactor tower and chemical storage take up significant space and weight, making them less practical for space-limited, e.g., offshore applications.

One mole of triazine reacts with two moles of H₂S to form dithiazine, the main byproduct. An intermediate product is formed, but such product is rarely observed. Reacted triazine byproducts are readily biodegradable and relatively non-toxic. Unreacted, excess triazine has very high aquatic toxicity and a tendency to form carbonate scale with produced water or sea water; this can result in emulsion stabilization, and increased overboard oil-in-water (OIW) content.

Unreacted triazine is also problematic for refineries as it impacts the desalting process and can cause accelerated corrosion within crude oil distillation units. It can also cause foaming in glycol and amine units and cause discoloration of glycol units. Unpleasant odor has also been reported with excess triazine usage, but some suppliers offer low-odor versions. Triazine itself is relatively safe to handle, but it can cause chemical burns upon contact.

There is a need for improved treatment of produced well fluids to scavenge H₂S.

### SUMMARY OF INVENTION

One aspect of the invention is a wellbore fluid treatment method. A system according to this aspect of the invention includes a pressure vessel for containing concentrated hydrogen sulfide scavenging reagent. The pressure vessel is closed to atmospheric pressure. A first controllably operated valve is disposed in fluid communication between an outlet of the pressure vessel and a well for selectively controlling the flow of the reagent from the pressure vessel to the well. A pressurized gas is disposed in the pressure vessel wherein the pressure exerted by the pressurized gas causes the reagent to flow from the pressure vessel to the well through the first valve when the first valve is opened. A second controllably operated valve is disposed in fluid communication between the well and an outlet of a fluid supply tank for selectively controlling flow of fluid in the tank to the well. The system includes a controller for selectively operating the first valve and the second valve. The fluid tank is replenished by fluid produced from the well. In another embodiment, the pressure vessel and the first valve may be substituted by a liquid chemical pump. In either embodiment, the reagent is injected into the well while fluid in the tank is contemporaneously allowed to flow into the well by gravity.

Other aspects and advantages of methods according to the present disclosure will be apparent from the following description and the appended claims.

### BRIEF DESCRIPTION OF DRAWINGS

FIG. 1 shows an example automatic treatment system according to one embodiment.

FIG. 2 shows a wellbore pump controller that may be used to communicate a signal to the automatic treatment system of FIG. 1 that corresponds to whether a well pump is operating or is shut off.

### DETAILED DESCRIPTION

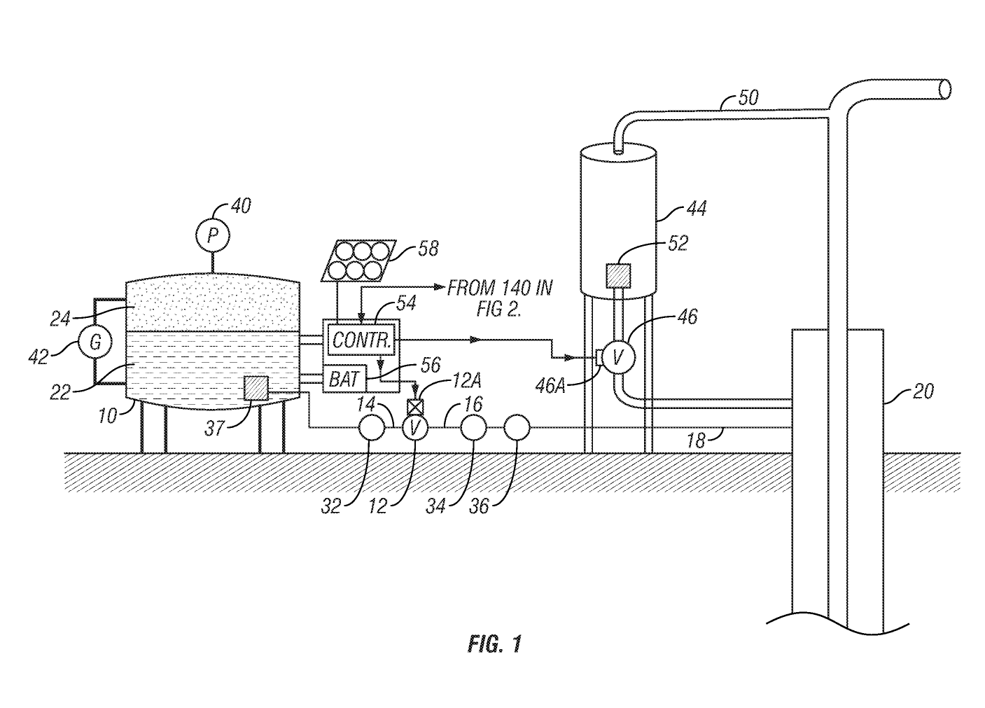

An example embodiment of a chemical treating system according to the invention is shown schematically in FIG. 1. A chemical dispenser vessel 10, substantially as described in U.S. Pat. No. 5,209,300 to Ayres, incorporated herein by reference, includes a container which is capable of holding an internal pressure without failure. The vessel 10 is distinguishable from containers such as tanks which may only be designed to withstand the hydrostatic pressure exerted by fluid in the tank. Preferably, the chemical dispenser vessel 10 is made from glass fiber, carbon fiber or composite fiber reinforced plastic, from stainless steel, or from any other material which is resistant to degradation induced by chemicals and corrosive gases. In some embodiments, the chemical dispenser vessel 10 may include an inner lining (not shown) resistant to chemical attack. A first control valve 12, which in the present embodiment may be actuated by an actuator 12A, which can be a solenoid or the like, has an inlet end 14 in fluid communication with the interior of the chemical dispenser vessel 10. An outlet end 16 of the valve 12 is connected to one end of a fluid injection line 18. The other end of the fluid injection line 18 is coupled to a hydrocarbon producing well 20. Alternatively, the actuator 12A can be a motor/gear set.

A hydrogen sulfide scavenging reagent 22 may contained in the chemical dispenser vessel 10 in liquid form. In the present example embodiment, the hydrogen sulfide scavenging reagent 22 may comprise liquid-state triazine or a concentrated aqueous solution thereof (e.g., 5 to 80 percent by weight of triazine in water).

As shown in FIG. 1, a pressurized gas 24 is also disposed in the chemical dispenser vessel 10. The pressurized gas 24 preferably includes one or more chemically inert gases, which do not chemically react with the hydrogen sulfide scavenging reagent 22. The gas 24 may comprise readily available gases such as nitrogen, helium, argon or carbon dioxide. The pressurized gas 24 is initially charged to a pressure which is less than the condensation pressure for such gas. The condensation pressures are commonly known for each gas, and are not exceeded within the chemical dispenser vessel 10 to prevent the mixing, in the liquid phase, of the pressurized gas 24 with the hydrogen sulfide scavenging reagent 22. In addition, the density of pressurized gas 24 is preferably less than the density of the H₂S scavenging reagent 22 so that the H₂S scavenging reagent 22 is concentrated toward the bottom end of chemical dispenser vessel 10, and the pressurized gas 24 is concentrated toward the upper end of the chemical dispenser vessel 10. As shown in FIG. 1, the pressurized gas 24 is in contact with the hydrogen sulfide scavenging reagent 22 and pressurizes the hydrogen sulfide scavenging reagent 22 to the same pressure as that of the pressurized gas 24.

As shown in FIG. 1, a pressure regulator 32 can be installed between the outlet of the vessel 10 and an inlet 14 of the control valve 12. The pressure regulator 32 controls the pressure of the chemical 22 which is communicated to the inlet 14 of the valve 12. For example, if the pressure of the pressurized gas 24 and the hydrogen sulfide scavenging reagent 22 in the vessel 10 is 500 pounds per square inch (psi), the regulator 32 can reduce the pressure of the hydrogen sulfide scavenging reagent 22 at the inlet 14 of the valve 12 to a selected pressure that is greater than the well 20 pressure. As a representative example, if the pressure of the well 20 is 90 pounds per square inch (psi), and the desired pressure differential across the valve 12 is 10 psi, then the regulator 32 can be set to reduce the pressure of the chemical 22 from 500 psi to about 100 psi. The regulator 32 should not reduce the pressure of the hydrogen sulfide scavenging reagent 22 below the pressure in well 20 because this would prevent the chemical 22 from entering the well 20. To prevent the accidental or inadvertent backflow of well fluids into fluid line 18, a check valve 36 can be installed in the line 18. The control of the pressure differential across the valve 12 can be important because the flow rate through certain types of valves is dependent on the size of the valve orifice and the pressure differential between the valve inlet and valve outlet ports. As the pressure differential across a valve increases, the flow rate through the valve will typically increase unless the valve is designed to maintain a steady flow rate in response to varying flow pressures. As steady rate valves may be more expensive than other valves which do not have a pressure compensation feature, the pressure regulator 32 is an inexpensive solution for controlling the flow rate of the hydrogen sulfide scavenging reagent 22 through the valve 12. The regulator 32 is also useful because the use of the regulator 32 in conjunction with the valve 12 permits the precise metering of small quantities of the hydrogen sulfide scavenging reagent 22.

In some embodiments, such as shown in FIG. 1, a second regulator 34 may be located between the valve 12 and the well 20. The valve 12, the first regulator 32, and the second regulator 34 are each in fluid communication with the interior of the vessel 10 and the well 20. In the present embodiment, any pressure fluctuations in the vessel 10 and in the well 20 are thus isolated from the valve 12. Consequently, the pressure differential acting across the valve 12 can be precisely controlled, thereby permitting effective control over the flow rate of the hydrogen sulfide scavenging reagent 22 through the valve 12. The present embodiment permits the flow rate of the hydrogen sulfide scavenging reagent 22 to be controlled to a very precise rate even substantially less than one one-thousandth of a gallon per day.

In operation, the valve 12 is initially closed to prevent the release of the hydrogen sulfide scavenging reagent 22 from the vessel 10. The valve 12 is then selectively opened and the pressurized gas 24 urges the hydrogen sulfide scavenging reagent 22 through the first regulator 32, the valve 12, the second regulator 34 through the line 18, and into the well 20.

Preferably, the opening of the valve 12 is timed to selectively control the flow of hydrogen sulfide scavenging reagent 22 into well 20. The valve 12 can be operated for particular open durations to selectively increase or decrease the amount of the hydrogen sulfide scavenging reagent 22 injected into the well 20. The precise injection amount of the hydrogen sulfide scavenging reagent 22 accomplishes several objectives. Certain wells may require large volumes of the hydrogen sulfide scavenging reagent to accomplish the desired function, i.e., scavenging hydrogen sulfide from fluids present in the well 20. Other wells may require only relatively small quantities of reagents to accomplish the desired results. For example, certain wells may require only a fraction of a gallon per day to accomplish the desired result, and the injection of additional reagent is unnecessary to the operation of the well. If more reagent than required is injected into the well, then the excess reagent may remain in solution in the well fluid, which has been demonstrated to reduce certain types of bacteria in the well fluid. Reducing such bacteria may further reduce the amount of hydrogen sulfide present in the well fluids.

The apparatus can be configured to control the flow of hydrogen sulfide scavenging reagent 22 by selecting the operating time and frequency of operation of the valve 12 from any amount, ranging from essentially a continuous discharge of the hydrogen sulfide scavenging reagent 22 from the vessel 10, to any amount even as small as one one-thousandth of a gallon per day or less.

As previously explained, the check valve 36 may also be installed in the injection line 18 to prevent the backflow of fluids in the well 20 into the valve 12 or the vessel 10. This feature is desirable because a well operator could accidentally pressurize well 20 to a pressure higher than that of the chemical 22 in the vessel 10. In some embodiments, this function could be incorporated into the design of the valve 12.

In some embodiments, a float 37 or similar means can be located in the vessel 10 to prevent the pressurized gas 24 from exiting the vessel 10. The float 37 has a density less than that of the hydrogen sulfide scavenging reagent 22 and is buoyant therein. As the level of hydrogen sulfide scavenging reagent 22 is lowered in the vessel 10 by releasing the chemical 22 through the valve 12, the float 37 will be lowered in the vessel 10. When the float 37 reaches a selected position within the vessel 10, the float 37 seals the outlet of the vessel 10 to prevent the release of the pressurized gas 24 from the vessel 10. This function can be performed other than by using the float 37. For example, a liquid level gauge 42 could be used to indicate the level of the chemical 22 within the vessel 10 so that an operator could visually check the level of the chemical 22. In other embodiments, mechanical, electrical, or electronic equipment could be used to indicate the level of the hydrogen sulfide scavenging reagent 22 within the vessel 10 or, alternatively, to seal the outlet when the level of the hydrogen sulfide scavenging reagent 22 in the vessel is lowered to a certain position. A pressure gauge 40 can be attached to vessel 10 to measure the pressure of the pressurized gas 24. The gauge 42 can be attached to the vessel 10 for measuring the quantity of the hydrogen sulfide scavenging reagent 22 in the vessel 10. The gauge 42 can comprise many different embodiments such as sight glasses, electromagnetic switches, and other devices well-known in the art. In addition, the gauge 42 may comprise a flow meter which measures the quantity of fluid flowing from the vessel 10 When the fluid quantity flowing from the vessel 10 is compared to the quantity of the chemical 22 initially installed in the vessel 10, the quantity of the chemical 22 in the vessel 10 at any point in time can be determined.

The amount of hydrogen sulfide scavenging reagent to be dispensed into the well 20 may be related to concentration of hydrogen sulfide in the produced fluid as follows. For each 1,000 standard cubic feet of produced or exsolved gas (gas at 25 degrees C. temperature and 1 atmosphere pressure) X the hydrogen sulfide concentration in the gas in parts per million (PPM H₂S) divided by 11.135 equals the weight of hydrogen sulfide in the gas. If the hydrogen sulfide scavenging reagent is triazine, an effective amount of triazine to introduce into the well fluid may be 0.9 gallons per pound H₂S for an aqueous solution of 40% active triazine. Because the hydrogen sulfide scavenging reagent will be dissolved with produced well fluid when the reagent is introduced into the well, the hydrogen sulfide scavenging reagent may be introduced in amounts that exceed the stoichiometric amount needed to fully scavenge the H₂S. Thus, in the present example embodiment, excess diluted triazine may remain in the well 20. It has been observed that in diluted form as contemplated herein, triazine does not have a tendency to precipitate solids or form scale as it may in concentrated form. It has also been observed that unreacted triazine in the well fluid may tend to destroy bacteria present in the well fluid that themselves may contribute to the presence and concentration of H₂S in the well fluid. Thus, allowing excess diluted triazine to remain in the well fluid may itself result in reduction in the amount of H₂S that is required to be scavenged. Such reduction in the amount of H₂S may result in corresponding reduction in the required amount of hydrogen sulfide scavenging reagent (triazine) required to fully scavenge the H₂S from the well fluid.

In the present embodiment, the control valve 12 can be operated electrically, such as by the actuator 12A. The actuator 12A can be operated by a controller 54 of any type known in the art, such as a programmable logic controller, for electronic control of operation of a process operating device. The controller 54 may be supplied with electrical power by a battery 56. The battery 56 may be recharged by a solar cell 58. The foregoing electrical power to operate the controller 54 and the actuator 12A are not intended to ultimately limit the scope of the disclosure, but are preferred for economy and reliability of operation.

The present embodiment includes a fluid storage tank 44. The fluid storage tank 44 receives produced fluid from the well 20 through a flowline 50 coupled to an outlet of the well 20. The fluid storage tank 44 is preferably made so that it can hold internal pressure equal to the pressure at the outlet of the well 20, and is thus closed to the atmosphere. As fluid is produced from the well 20, some of it will enter the flowline 50 and ultimately fill the fluid storage tank 44. The fluid storage tank 44 may include at its discharge end a float 52 similar in operation to the float 37 on the vessel 10. The outlet of the fluid tank 44 is in hydraulic communication with the well 20 through a second control valve 46 operated by a motor/gear set 46A. It has been determined through experimentation with various types of valve actuators that using a motor/gear set to actuate the second valve 46 reduces the incidence of improper valve operation due to contamination of the valve from materials present in the fluid produced from the well 20. A motor/gear set is also less susceptible to the valve 46 being improperly opened by high pressures extant on the outlet side of the valve 46. The motor/gear set 46A can also be operated by the controller 54. As will be explained below, when the valve 46 is operated, fluid in the tank 44 may flow into the well 20. By having equal pressure on the well 20 and the tank 44, fluid in the tank 44 may simply flow by gravity into the well 20.

In the present embodiment, the controller 54 may be programmed to operate the first control valve 12 to selectively discharge the hydrogen sulfide scavenging reagent 22, and the control valve 46 for the fluid stored in the fluid storage tank 44 at the same selected times and durations. Operating the first control valve 12, as previously explained, causes injection of a selected amount of the hydrogen sulfide scavenging reagent 22 into the well 20. At substantially the same time, operation of the second control valve 46 causes the contents of the fluid storage tank 44 to flow by gravity into the well 20. Thus, a hydrogen sulfide scavenging reagent treatment is supplied to the well 20 that is already dispersed in fluid (which may include oil and/or water) prior to reaching the bottom of the well 20, in the event the fluid level in the well 20 is too low to properly dilute the hydrogen sulfide scavenging reagent 22 by itself.

In some embodiments, the float 52 may include a switch (not shown separately) so that the controller 54 will not operate the valves 12, 46 if the level of water in the water tank 44 falls below a selected level. In some embodiments, the second valve 46 can be operated to discharge essentially the entire contents of the fluid storage tank 44 at each operation. In other embodiments, the second valve 46 can be operated to discharge a selected amount of the contents of the fluid storage tank 44. In other embodiments, the second regulator 34 and the check valve 36 may be omitted. Additionally, the controller 54 can be programmed to operate the first valve 12 and the second vale 46 with respect to any timing reference, such as during periods of time in which a pump (not shown) is operating to lift fluids out of the well 20, or at times during which the pump (not shown) is not operating. In some embodiments, the controller 54 can be programmed to operate the valves 12, 46 simultaneously, or at different times from each other.

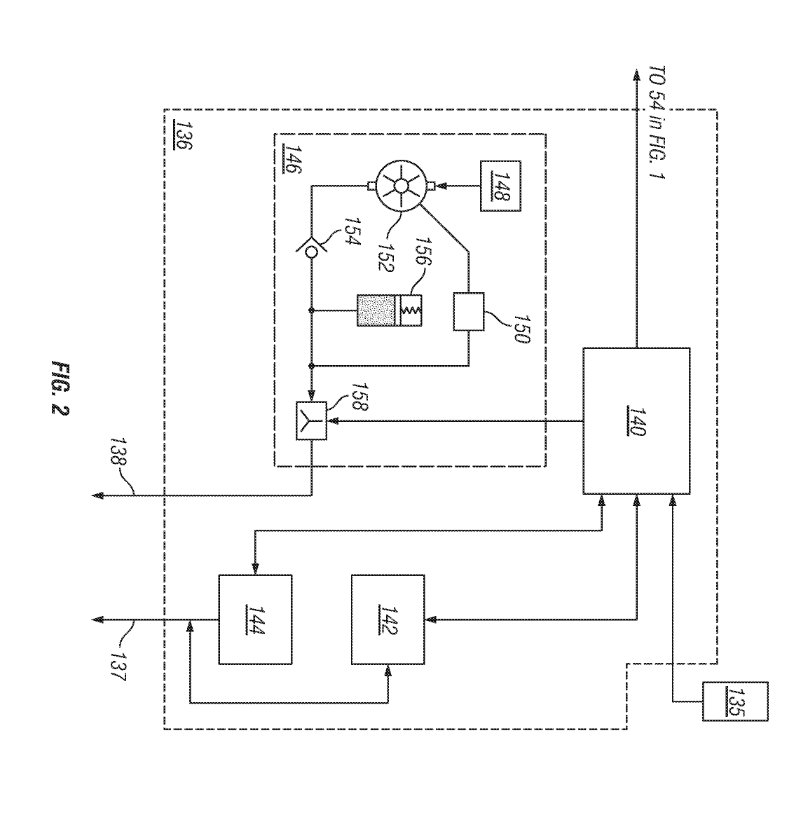

FIG. 2 shows a schematic diagram of one example of a control unit 136 for a wellbore pump (not shown), which may be an electric submersible pump (ESP), or any other type of pump. The control unit 136 may include a telemetry transceiver 142 that can receive and decode telemetry from telemetry signals transmitted along a power cable 137 that supplies electrical power to operate the pump. Decoded telemetry, representing measurements from the various sensors (e.g., fluid level or pressure sensors) may be communicated to a central processor (“CPU”) 140. The CPU 140 may be any microprocessor based controller or programmable logic controller, such as one sold under the trademark FANUC, which is a trademark of General Electric Corp., Fairfield, Conn. A control output of the CPU 140 may be coupled to a motor speed controller 144 of any type known in the art, such as an AC motor speed controller. The AC motor speed controller 144 may be operated by the CPU 140 to cause the motor (not shown) and thus the pump (not shown) and an optional downhole oil/water separator (not shown) to operate at a selected rotational speed. Another control output of the CPU 140 may be coupled to an actuator control 146. The actuator control 146 provides hydraulic pressure to operate a control valve associated with the pump (not shown). Components of a typical actuator control may include a hydraulic pump 152, the inlet of which is coupled to a reservoir 148 of hydraulic fluid. Discharge from the pump passes through a check valve 154 and charges an accumulator 156 configured to maintain a selected system fluid pressure. A pressure switch 150 may stop the pump when the selected system pressure is reached. Hydraulic pressure may be selectively applied to the hydraulic line through a throttling valve 158. The throttling valve may be an electric over hydraulic operated valve coupled to the control output of the CPU 140. Thus, the CPU 140 may be programmed to select both the motor speed and the degree to which the control valve (not shown) is opened. The CPU 140 may be programmed to stop the pump entirely when certain conditions exist in the well (20 in FIG. 1) such as the fluid level in the well being too low, so as to avoid “pump off”, or dispensing hydrogen sulfide scavenging reagent when there is insufficient fluid in the well (20 in FIG. 1) to properly dilute the hydrogen sulfide scavenging reagent. The CPU 140 may also send a signal to the controller (54 in FIG. 1) indicative of whether the pump (not shown) is operating or not operating.

While the foregoing example of a pump control unit 136 is used with an ESP, it should be clearly understood that other types of pump control units may be used in other embodiments, and with other types of pumps. For example, the pump may be a standing valve/traveling valve pump operated by “sucker rods” that reciprocate to lift well fluid to the surface. Such sucker rods may be operated by an hydraulic or pneumatic lift unit or a walking beam. The type of pump and control unit is not intended to limit the scope of the disclosure. For purposes of the present disclosure, it is only required that the control unit 136 communicate to the controller (54 in FIG. 1) when the pump is operating or not operating.

Referring back to FIG. 1, the controller 54 may be preprogrammed or otherwise configured to cause operation of the valve 12 to operate at selected times and for selected durations at each time. The controller may be programmed to operate the second control valve 46 at the same or at other selected times and for selected durations. In the present embodiment, when one of the selected times occurs, the controller 54 may interrogate the CPU (140 in FIG. 2) to determine whether the well pump (not shown) is operating or is switched off. If the controller 54 receives indication that the well pump is switched off, the controller 54 may be programmed not to operate either the valve 12, thus not dispensing any chemical, and, optionally, the second control valve 46 so as not to dispense any stored produced water into the well 20. The controller 54 may include an internal register or counter that may be incremented for each time that a selected time occurs and the controller 54 does not operate the valve 12 because of a signal from the CPU (140 in FIG. 2) indicating that the pump is switched off. If in any subsequent selected time at which the controller 54 is scheduled to operate the valve 12 a pump not operating signal is received, the counter in the controller 54 may again be incremented. The foregoing may continue until which time as a selected time to operate the valve 12 coincides with a time a which a signal from the CPU (140) indicates that the well pump is operating. When such selected time with coincident pump operation takes place, the controller 54 may be programmed or configured to operate the valve 12, and optionally the second control valve 46 to open for a duration equal to the product of the preselected duration for an individual hydrogen sulfide scavenging reagent treatment and the number of non-operative selected times stored in the register or counter, plus the single treatment duration (thus the product of the treatment duration and the counter value plus one) in the controller 54. By accumulating a number of treatments that are not made at the selected times because the pump operating signal is not communicated to the controller 54, the likelihood of inadequate treatment of the well 20 may be reduced. Some types of chemical treatment require specific volumes or amounts of treatment chemical be dispensed into the well during a certain period of time. The accumulation feature of the present embodiment may help ensure that such chemical treatments are properly dispensed into the well 20.

In some embodiments, the controller 54 may be further programmed to reset the counter to zero or any other selected number after a predetermined time interval has elapsed in which no pump operating signal is present at the controller 54. While not limiting the scope of the present disclosure, such predetermined time interval may be one or two days. By resetting the counter after a predetermined time interval with no pump operating signal, it may be possible to avoid injecting excessive and unnecessary amounts of hydrogen sulfide scavenging reagent into the well 20. Non-limiting examples of situations in which a predetermined time interval may be exceeded with no pump operating signal is when the well is undergoing repairs or workover operations, or when the well pump or components thereof are being serviced or replaced.

Embodiments of a method according to the present disclosure provide a system for automatic hydrogen sulfide scavenging treatment of a well in which the treating reagent is pre-dispersed in a fluid obtainable from the well itself. Embodiments of the according to the present disclosure can provide properly dispersed hydrogen sulfide scavenging reagent for a well even in the event the well is “pumped off” (meaning that the fluid level is insufficient for a downhole pump to lift fluid to the Earth's surface).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for scavenging hydrogen sulfide from fluids produced into a well, comprising:
pressurizing a hydrogen sulfide scavenging reagent to a pressure above a pressure in the well;
at selected times enabling the pressurized hydrogen sulfide scavenging reagent to flow into the well;
storing fluid produced from the well, the storing performed at a pressure extant on the well; and
at selected times making an hydraulic connection between the stored, produced fluid and the well so that the produced fluid flows into the well by gravity.

2. The method of claim 1 wherein the selected times of enabling the hydrogen sulfide scavenging reagent to flow into well have a duration and frequency selected to inject a predetermined quantity of the hydrogen sulfide scavenging reagent into the well.

3. The method of claim 1 further comprising determining an amount of the stored fluid and stopping the making the hydraulic connection between the chemical and the well and the stored fluid and the well when the amount of stored fluid falls below a selected threshold.

4. The method of claim 1 wherein the hydrogen sulfide scavenging reagent comprises triazine.

5. The method of claim 4 wherein triazine is introduced into the well at a rate of 0.9 pounds of 40 percent active triazine per pound of hydrogen sulfide in gas present in fluids produced from the well.

6. The method of claim 1 wherein the pressurizing the hydrogen sulfide scavenging reagent comprises applying pressurized gas to an interior of a storage vessel having the hydrogen sulfide scavenging reagent stored therein.

7. The method of claim 6 wherein the pressurized gas is non-reactive with the hydrogen sulfide scavenging reagent.

8. A method for injecting a hydrogen sulfide scavenging reagent into a well, comprising:
selecting times at which to operate a chemical dispenser to inject a selected amount of the hydrogen sulfide scavenging reagent into a well within a predetermined time interval;
at each selected time, detecting a signal generated by a pump controller corresponding to whether a wellbore fluid lift pump is operating, the wellbore fluid lift pump arranged to lift fluid from the wellbore;
detecting at at least one selected time within the predetermined time interval that the wellbore fluid lift pump is not operating, inhibiting operation of the chemical dispenser and incrementing a counter in a controller in signal communication with the chemical dispenser;
during the predetermined time interval at a subsequent selected time coincident with operation of the wellbore fluid lift pump so as to dispense an amount of the hydrogen sulfide scavenging reagent equal to the product of the number in the counter plus one multiplied by the selected amount of hydrogen sulfide scavenging reagent into the well to be injected at each selected time.

9. The method of claim 8 further comprising dispensing a corresponding amount of produced fluid into the well when the hydrogen sulfide scavenging reagent is dispensed into the well, wherein the dispensing the produced fluid comprises:
storing fluid produced from the well, the storing performed at a pressure extant on the well; and
at selected times making a hydraulic connection between the stored, produced fluid and the well so that the produced fluid flows into the well by gravity.

10. The method of claim 9 further comprising determining an amount of stored produced fluid from the well and stopping dispensing the stored fluid into the well when the amount of stored fluid falls below a selected threshold.

11. The method of claim 8 wherein the selected times of have a duration and frequency selected to inject a predetermined quantity of the hydrogen sulfide scavenging reagent into the well during the predetermined time interval.

12. The method of claim 8 wherein the dispensing the hydrogen sulfide scavenging reagent comprises:
applying compressed gas to the chemical to pressurize the hydrogen sulfide scavenging reagent;
at the subsequent selected time when the pump is operating, making a hydraulic connection between the pressurized hydrogen sulfide scavenging reagent and an interior of the well, thereby enabling the pressurized chemical to flow into the well.

13. The method of claim 8 further comprising resetting the counter to zero after the predetermined time interval has elapsed.

14. The method of claim 8 wherein the hydrogen sulfide scavenging reagent comprises triazine.

15. The method of claim 14 wherein triazine is introduced into the well at a rate of 0.9 pounds of 40 percent active triazine per pound of hydrogen sulfide in gas present in fluids produced from the well.
